(19) United States
(12) Patent Application Publication
(10) Pub. No.: US 2017/0177989 A1
(43) Pub. Date: Jun. 22, 2017

(54) AIRTIGHT CONTAINER ID HAVING A PRESSURE CLOSURE, WITH A STEEL RING FASTENER, SELF ADHESIVE, CARABINEER, BELT STRAP OR SEALED, FOR SIM OR MICRO SD CARD

(71) Applicant: Alberto Enrique PASCUAL, Mar del Plata (AR)

(72) Inventor: Alberto Enrique PASCUAL, Mar del Plata (AR)

(21) Appl. No.: 15/152,644

(22) Filed: May 12, 2016

(30) Foreign Application Priority Data
Dec. 22, 2015 (AR) 20150104251

(51) Int. Cl. G06K 19/077; B65D 25/22; B65D 85/38; A45F 5/02

(52) U.S. Cl. CPC G06K 19/07739; A45F 5/021; B65D 25/22; B65D 85/38

(57) ABSTRACT

An identifier for persons, pets or objects.

### FIELD OF THE INVENTION

An identifier for persons, pets or objects.

### BACKGROUND OF THE INVENTION

Highlighting the technological level achieved in tracking systems, dedicated to dogs, these similar to cellular phones, also interact in the cloud, and meet all kinds of functions, to inform us of every movement, but these would be very disproportionate for small pets, in addition would have the hassle of having to load them periodically, that if it is impossible or suffers a malfunction. It is here where we appreciate the versatility of the small system of the present invention, which can be used as a second option, to have more coverage on the time axis.

Without a doubt, one of the globally recognized inventions of medical science is the wheelchair. Thanks to technological advancement, there are very complicated, electrical, robotic arms, or brain reading for quadriplegic, but the one that we use in guards' rooms or Hospital corridors, will undoubtedly be the most simple and functional.

The same goes for therapeutic monitoring devices.

### SUMMARY OF THE PRESENT INVENTION

The present invention takes into account two important functions, the location and communication of possible lost cases, as well as the data input, oriented to different disciplines.

In the first instance, and as a result of the needs, requirements, and proportionality of the container, it should be considered different forms and suitable materials.

In the event that it contains as an element, a SIM card, Micro SIM, Nano SIM, or Micro SD. The container must be airtight, optionally pressurized, in two parts linked by a flexible, which also optionally acts as a support, or will be linked to the steel rings, carabineers, closures or links type jewelry, as buttons pins, necklaces, bracelets, or bangles, etc.

May also have a self-adhesive material on one side, to locate it or adhere, in case of document cases, wallet, or a base with belt straps, in case of being attached to a belt, collar, or pet strap.

In the case of clothing, machinery, or maintenance tasks, can be adapted to seals that are fit for these purposes.

Adding to high risk sports, such as mountain climbing or skiing, by using rings in the closures, clothing, backpacks, or lifejackets.

The possible content may now be detailed, citing different possibilities of communication and content.

In the case of preventing the eventual loss of a child or a pet, it would suffice with a SIM card, a Nano SIM card, or a Micro SIM card.

The card will have as information in the first instance, the name and/or last name, and the telephone number of the user.

In addition, can mention a Link to a file, with photographs or notes.

In the case of document holders or wallet, in addition to the relevant contact details of the user, it can contain a reward or recognition to the return of the same.

Of course that is instructed to hide the data, such as address or complete identity, for the protection of the user.

If we refer to a Haute Couture garment, or to a complicated technical part, such as a spare or maintenance parts, it will include a Micro SD card inserting the required information therein.

In the case of a single note, bar codes, or multiple and combinations thereof, a cartridge will be required as a shape of the container.

As follows, there is an analysis, referring to the possibilities in terms of proportionality, competitiveness, and technological level, placed between the pre-existing technologies on the market.

Starting depending on the size, by the smaller, for example, a small kitten is given to us as a gift, they are really small, placing then a medal may be uncomfortable, some people opt for writing a phone number in a collar, which looks sloppy. Now if a necklace or ribbon is used, with a container for a SIM card, the size would be the most appropriate, in addition, the container may include a beautiful logo, which would add beauty and functionality.

Another common example, in our lives, is the anxiety that we experience when we have to go with kids to very densely populated places, for example, beaches, public transportation stations, or amusement parks. The fear to lose the kids is inevitably present.

Imagine that with only a pass by a store or a kiosk, and acquired ID, and being sure that our cell phone is ready to receive calls, this fear will disappear, or at least would be attenuated.

The speed of this mechanism is highlighted, since there are more sophisticated mechanisms, but it is noted in this example, the functionality and speed of this device.

If we imagine a child distressed, crying, lost in a resort, in the presence of a lifeguard, the latter has no time or signal to be lowering the appropriate scanning program, while with the chip, it is inserted into a cell phone, and would quickly be in contact with the parents. Additionally, this identifier, which is very economical, could provide in the same kiosk as the resort.

What will happen when this small container, placed on a chain, cord, bracelet, bangle, or into the neck of a victim, in an ambulance, and admitted to a guard, alert to a physician, or to a doctor on call, the existence of a clinical history.

With the possibility of a color-coded, to anticipate the origin the problem, if it is of an allergic, cardiac, hepatic or origin, etc.

It is what we claim this invention, its simplicity, elegance, and functionality.

Once this service is implemented, when a new cell phone device is acquired, and the data is updated on the notes, notebooks, wallet, and the keychain, this gadget that can be in transparent plastic, at first, to alert the user to the presence of a chip, or with the logo of a sponsor or provider of services company, will move to provide an important free service, for the benefit of the community.

### BRIEF DESCRIPTION THE FIGURES

FIG. 1 shows a front view of the identifier container of the present invention;

FIG. 2a shows a back view of the container of FIG. 1;

FIG. 2b shows a cross-sectional view of the top cover of the container of FIG. 2a taken along line E-E′;

FIG. 2c shows a cross-sectional view of the bottom cover of the container of FIG. 2a taken along line F-F;

FIG. 3 shows a front view of the container of FIG. 1 in a closed position and including diverse optional elements; and

FIG. 4 shows an exploded view of the container of FIG. 1 in a closed position.

### DETAILED DESCRIPTION OF THE INVENTION

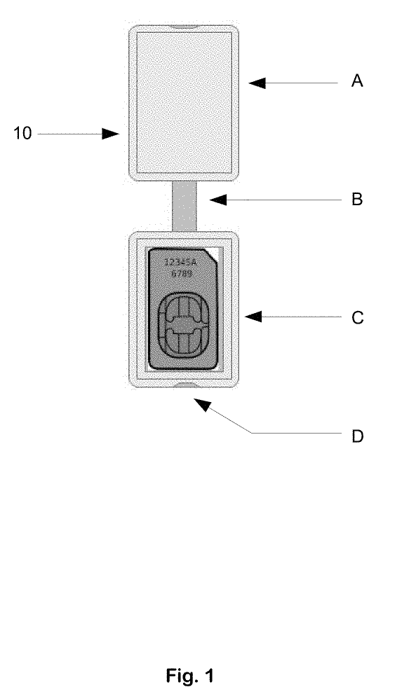

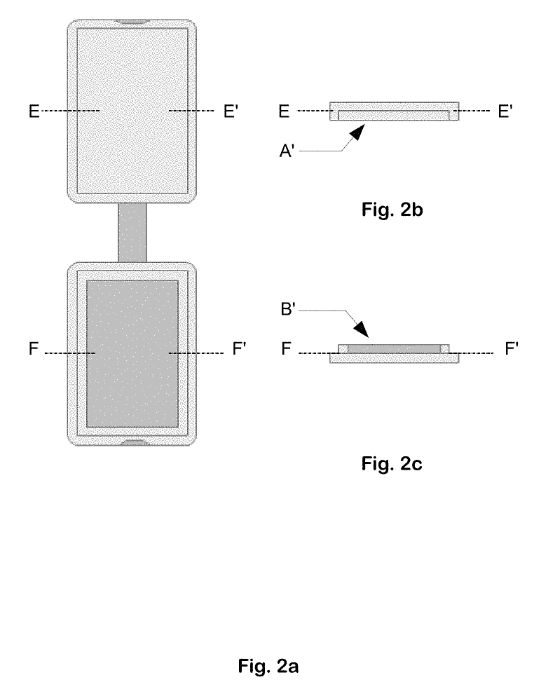

As can be seen in FIGS. 1-4, the identification container includes a A) cover or top cover, a hollow internal space A′ (FIG. 2b);

(B) flexible strap to connect the top cover A with the bottom cover B;

(C) base or bottom cover, a hollow internal space B′ (FIGS. 2c); and

(D) an indent or grin for disassembly or opening.

(L) an airtight chamber formed by the hollow internal space A′ of the top cover A and the hollow internal space B′ of the bottom cover B when the top cover A and the bottom cover B are in a closed position;

wherein the airtight chamber is adapted to receive a SIM card, a Micro SIM card, a Nano SIM card, a Micro SD card, or a document with information.

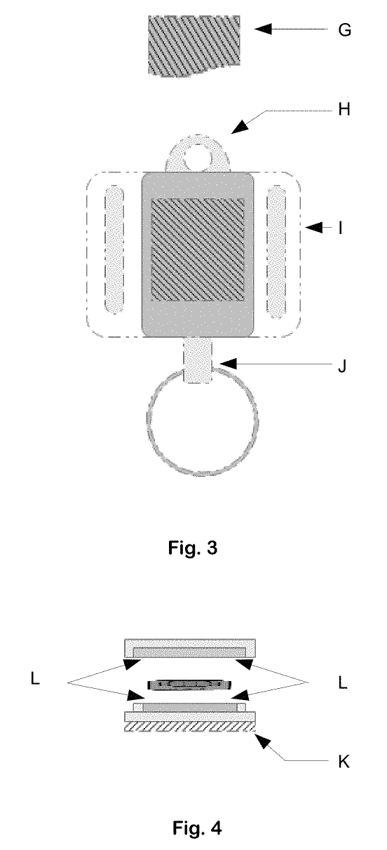

As can be seen in FIG. 3, the container may include:

(G) a space for the logo

(H) optional an upper grommet with the consequent possibility of attaching a cord or a seal.

optional a belt strap

(J) optional a support with keychain ring

(K) optional support with self-adhesive material.

The identification container according to claim 6, wherein the document includes information about the user, the information selected from the group consisting of medical condition, personal information, medical alerts, files, data, videos, graphics, or QR codes.

1-5. (canceled)

6. An identification container to include information about a user, the identification container comprising:
a top cover having a hollow internal space;
a bottom cover having a hollow internal space;
an airtight chamber formed by the hollow internal space of the top cover and the hollow internal space of the bottom cover when the top cover and the bottom cover are in a closed position;
a flexible strap to connect the top cover with the bottom cover;
an indent or grin located on an edge of the bottom cover;
wherein the airtight chamber is adapted to receive a SIM card, a Micro SIM card, a Nano SIM card, a Micro SD card, or a document with information.

7. The identification container according to claim 6, further including a space for placing a logo, the space located on the top cover of the bottom cover;

8. The identification container according to claim 6, further including a grommet adapted to be attached to a cord or a seal.

9. The identification container according to claim 6, further including a belt strap.

10. The identification container according to claim 6, further including a keychain ring.

11. The identification container according to claim 6, further including a self-adhesive material secured to the top cover or the bottom cover.

12. The identification container according to claim 6, wherein the document includes information about the user, the information selected from the group consisting of medical condition, personal information, medical alerts, files, data, videos, graphics, or QR codes.
